(19) United States
(12) Patent Application Publication
(10) Pub. No.: US 2016/0093419 A1
(43) Pub. Date: Mar. 31, 2016

(54) COAXIAL CABLE

(71) Applicant: LS CABLE & SYSTEM LTD., Anyang-si (KR)

(72) Inventors: Sang-Sik SHIN, Daegu (KR); Jong-Seb BAECK, Daegu (KR); Seung-Yong SHIN, Anseong-si (KR)

(21) Appl. No.: 14/847,066

(22) Filed: Sep. 8, 2015

(30) Foreign Application Priority Data
Sep. 30, 2014 (KR) 10-2014-0130994

(51) Int. Cl. H01B 7/295; H01B 11/18; H01B 7/02; H01B 1/02; H01B 3/44

(52) U.S. Cl. CPC H01B 7/295; H01B 1/02; H01B 3/445; H01B 3/441; H01B 7/0216; H01B 11/1843

(57) ABSTRACT

The present invention relates to a coaxial cable, and more particularly, to a coaxial cable that satisfies a required flame-retardant grade and electrical characteristics and that is inexpensive to manufacture, compared to the related art.

### CROSS REFERENCE TO RELATED APPLICATION

This application claims the benefit of Korean Patent Application No. 10-2014-0130994, filed Sep. 30, 2014, which is hereby incorporated by reference in its entirety into this application.

### BACKGROUND OF THE INVENTION

1. Technical Field

One or more aspects of the present invention relate to a coaxial cable, and more particularly, to a coaxial cable that satisfies a required flame-retardant grade and electrical characteristics and that is inexpensive to manufacture, compared to the related art.

2. Description of the Related Art

A coaxial cable is a transmission medium in which a central insulated inner conductor is surrounded with a tubular outer conductor and a jacket is formed at an outer side of the tubular outer conductor. That is, and the coaxial cable is a type of a line via which a radio-frequency (RF) signal and the like are transmitted and in which an inner conductor, an insulator, an outer conductor, and a jacket are sequentially formed at a center thereof. Among flame-retardant coaxial cables, a PLENUM-grade coaxial cable may be used to build a distributed antenna system (DAS), etc. and has been mainly used for horizontal wiring in a building. In contrast, a riser coaxial cable, and the grade of which is lower than that of the PLENUM-grade coaxial cable maybe mainly used for vertical wiring when a DAS system is built. Such coaxial cables should satisfy a required communication cable attenuation or impedance standards.

In a PLENUM-grade coaxial cable according to the related art, a jacket located in an outer region is formed of a material having a very high oxygen index of 80% or more, e.g., flame-retardant Polyvinylidene fluoride (PVDF) having an oxygen index of 95%, so as to satisfy required flame-retardant characteristics.

Since flame-retardant PVDF has a very high oxygen index of 95%, flame-retardant characteristics can be easily achieved but flame-retardant PVDF is expensive. The jacket may be formed of polyvinyl chloride (PVC) that is relatively cheap or the like. However, even if flame-retardant particles are added to PVC so as to increase a flame-retardant grade thereof, an oxygen index of the resultant PVC is about 40 to 70%. Thus, and the oxygen index of the resultant PVC is lower than the oxygen index of PVDF. Thus, it is not easy to secure a PLENUM-grade flame-retardant performance by simply changing a material of an insulator in a state in which the other conditions are maintained to be the same.

Thus, there is a need to develop a new coaxial cable that may replace for a PVDF coaxial cable, that is inexpensive, and that satisfies a required PLENUM-grade flame-retardant grade and communication cable standards.

### SUMMARY OF THE INVENTION

Therefore, and the present invention may have been made in view of the above problems, and it may be an object of the present invention to provide a coaxial cable comprising an inner conductor formed of copper clad aluminum, an insulator configured to cover the inner conductor and formed of high-density polyethylene (HDPE), an outer conductor configured to cover an outer side of the insulator and formed of copper or aluminum and a jacket configured to cover an outer side of the outer conductor and formed of flame-retardant polyvinyl chloride (PVC).

The inner conductor may have a diameter of 3.0 mm to 5.0 mm.

The insulator may have a crisscross structure in which the inner conductor may be disposed to pass through a center of the insulator and a plurality of ribs extend in four directions.

A cross-sectional area of the insulator may be in a range of 10 mm2 to 16 mm2.

The outer conductor may have a corrugate tubular structure, and may have a thickness of 0.21 mm to 0.25 mm.

A corrugate tubular structure of the outer conductor may have a depth of 1.0 mm to 1.3 mm.

Flame-retardant polyvinyl chloride (PVC) used to form the jacket may have an oxygen index of 40 to 70.

The jacket may have an external diameter that may be in a range of 15 mm to 17 mm.

A loss in a 2-GHz signal per 100 meters may be 13.2 dB or less.

The coaxial cable satisfies a PLENUM-grade flame-retardant rank in the NFPA 262 test, a loss in a 2-GHz signal per 100 meters may be 13.2 dB or less, and a characteristic impedance of the coaxial cable may be 52Ω.

In accordance with an aspect of the present invention, and the above and other objects can be accomplished by the provision of a coaxial cable which includes an inner conductor at a center, an insulator covering an outer side of the inner conductor, an outer conductor covering an outer side of the insulator, and a jacket covering an outer side of the outer conductor, and the insulator forms an air layer between the inner conductor and the outer conductor, and the jacket may be formed of resin having an oxygen index of 40 to 70.

A cross-sectional area of the insulator may be 4.0% to 9.0% of a whole cross-sectional area of the coaxial cable, and the coaxial cable may have a peak flame spread of 1.52 m or less, a peak optical density of 0.5 or less, and an average optical density of 0.15 or less in the NFPA 262 test, may have a characteristic impedance of 48Ω to 52Ω, and may have a signal loss of 13.2 dB or less per 100 meters at a frequency of 2 GHz.

The inner conductor may be formed of copper clad aluminum.

The inner conductor may have a diameter of 3.0 mm to 5.0 mm.

The insulator may comprise an inner ring-shaped portion covering the inner conductor and a plurality of ribs extending from the inner ring-shaped portion in a radius direction.

The insulator may have a cross-sectional area of 10 mm2 to 16 mm2.

The outer conductor may be formed of copper or aluminum.

The outer conductor may have a corrugate tubular structure, and may have a thickness of 0.21 mm to 0.25 mm.

The outer conductor may have a corrugate tubular structure with ridges and furrow, wherein a depth of the corrugate tubular structure may be 1.0 mm to 1.3 mm, and the depth corresponds to the difference between heights of the ridges and the furrows of the corrugate tubular structure.

An external diameter of the coaxial cable may be in a range of 15 mm to 17 mm.

Four spaces are formed between the outer conductor and the insulator due to the plurality of ribs of the insulator.

The insulator may be formed of high-density polyethylene (HDPE).

The jacket may be formed of flame-retardant polyvinyl chloride (PVC).

In accordance with an aspect of the present invention, and the above and other objects can be accomplished by the provision of a coaxial cable comprising, an inner conductor having an external diameter of 5.0 mm or less, an insulator configured to cover the inner conductor, formed of high-density polyethylene (HDPE), and having across-sectional area of 10 mm2 to 16 mm2, and the insulator comprises

an inner ring-shaped portion covering the inner conductor and a plurality of ribs extending from the inner ring-shaped portion in a radius direction, an outer conductor configured to cover an outer surface of the insulator and having a corrugate tubular structure with ridges and furrows and a jacket configured to cover an outer side of the outer conductor, and formed of polyvinyl chloride (PVC) having an oxygen index of 40 to 70, and the coaxial cable may have an external diameter of 15 mm to 17 mm.

The inner conductor may be formed of copper clad aluminum.

The outer conductor may be formed of copper or aluminum.

The coaxial cable may have a peak flame spread of 1.52 m or less, a peak optical density of 0.5 or less, and an average optical density of 0.15 or less in the NFPA 262 test, may have a characteristic impedance of 48Ω to 52Ω, and may have a signal loss of 13.2 dB or less per 100 meters at a frequency of 2 GHz.

The outer conductor may have a corrugate tubular structure, and may have a thickness of 0.21 mm to 0.25 mm.

The corrugate tubular structure of the outer conductor comprises ridges and furrows, and the difference between heights of the ridges and furrows of the corrugate tubular structure may be 1.0 mm to 1.3 mm.

### BRIEF DESCRIPTION OF THE DRAWINGS

FIG. 1 is a perspective view of an inner structure of a coaxial cable according to an embodiment of the present invention.

FIG. 2 is a cross-sectional view of a coaxial cable according to an embodiment of the present invention.

FIG. 3 is a lengthwise cross-sectional view of a coaxial cable according to an embodiment of the present invention.

### DETAILED DESCRIPTION

Hereinafter, exemplary embodiments of the present invention will be described in detail with reference to the accompanying drawings. The invention is, however, not limited to embodiments set forth herein and may be embodied in many different forms. Rather, these embodiments are provided so that this disclosure will be thorough and complete and will fully convey the inventive concept to those of ordinary skill in the art. The same reference numerals represent the same elements throughout the drawings.

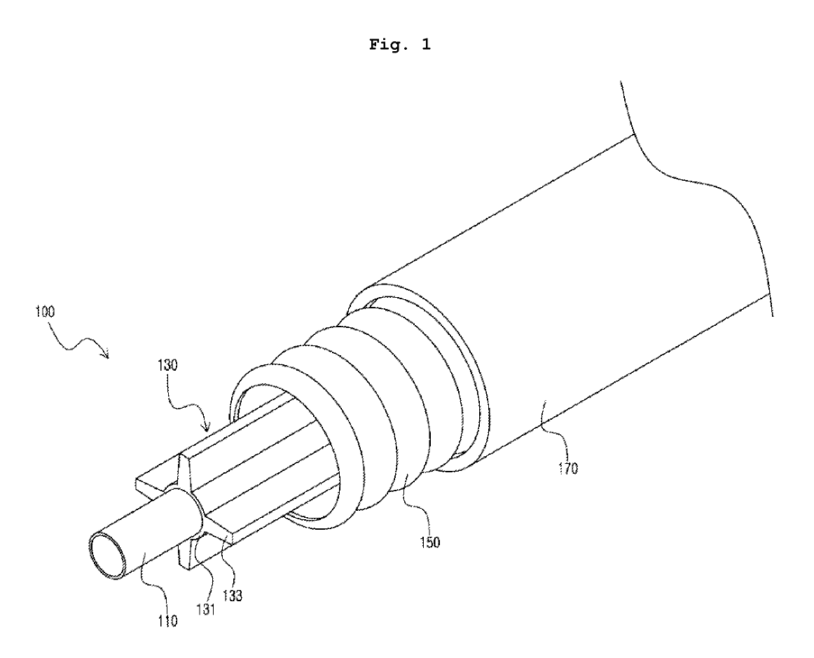

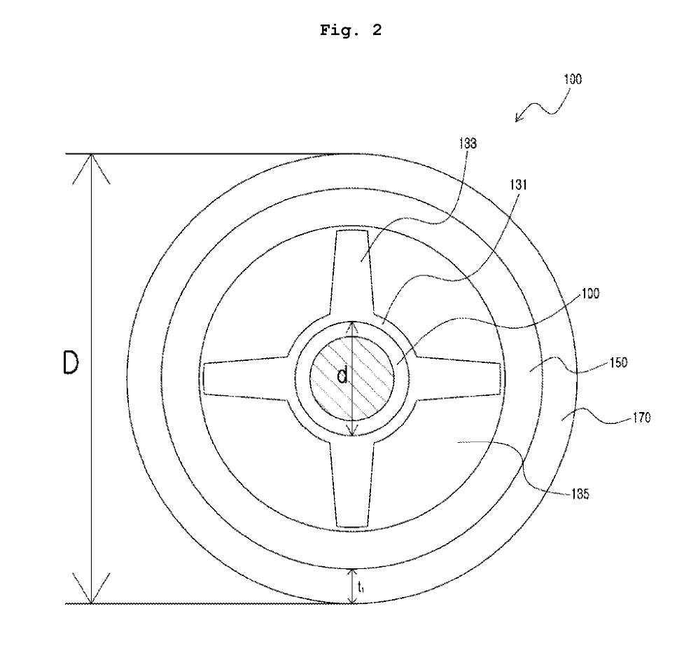

FIG. 1 is a perspective view of an inner structure of a coaxial cable 100 according to an embodiment of the present invention. FIG. 2 is a cross-sectional view of the coaxial cable 100 according to an embodiment of the present invention.

According to an embodiment of the present invention, and the coaxial cable 100 may include an inner conductor 110 formed of copper clad aluminum (CCA), an insulator 130 configured to cover the inner conductor 110 and formed of high-density polyethylene (HDPE), an outer conductor 150 configured to cover an outer side of the insulator 130 and formed of copper or aluminum, and a jacket 170 configured to cover an outer side of the outer conductor 150 and formed of flame-retardant polyvinyl chloride (PVC).

The inner conductor 110 may be formed of copper clad aluminum having a diameter of 3.0 mm to 5.0 mm. Copper clad aluminum is a conductive material developed according to a request for a light-weight and inexpensive conductor. Copper clad aluminum has the advantages of both of aluminum having light-weight and cheap characteristics and copper having conductive and tensile characteristics, and has a diameter that does not increase to a great extent, compared to pure copper. Thus, copper clad aluminum has recently been used to manufacture an inner conductor of a high-frequency coaxial cable or a power cable in the fields of mobile communication, community antenna television (CATV), etc.

The inner conductor 110 formed of copper clad aluminum is covered with the insulator 130.

The inner conductor 110 is located in a central region of the insulator 130 to pass through the insulator 130. Also, a plurality of ribs 133 extending in four directions are formed in the insulator 130 in a crisscross pattern. The inner insulator 130 is formed of high-density polyethylene (HDPE).

The insulator 130 may include an inner ring-shaped portion 131 having a pipe shape covering the inner conductor 110, and the plurality of ribs 133 extending from the inner ring-shaped portion 131 in a radius direction.

Each of the plurality of ribs 133 may protrude in a gentle spiral shape from the inner ring-shaped portion 131 in a lengthwise direction of the coaxial cable 100 such that the plurality of ribs 133 are spaced a predetermined distance from each other. In the embodiment of FIG. 1, and the coaxial cable 100 includes four ribs 133 formed in a crisscross pattern.

The plurality of ribs 133 protruding in the crisscross pattern may form an air layer in the insulator 130 while separating the inner conductor 110 and the outer conductor 150 from each other.

The air layer may be divided into several parts by the plurality of ribs 133. That is, four spaces may be formed between the outer conductor 150 and the insulator 130 by the plurality of ribs 133 of the insulator 130.

The outer conductor 150 is located at an outer side of the insulator 130. The outer conductor 150 may be formed of copper or aluminum.

The outer conductor 150 has a corrugate tubular structure. The flexible and strong properties of the outer conductor 150 may be reinforced due to the corrugate tubular structure. The outer conductor 150 may have a thickness t₂ of 0.21 mm to 0.25 mm.

An outer side of the outer conductor 150 may be covered with the jacket 170. The jacket 170 may be formed of flame-retardant polyvinyl chloride (PVC). And the jacket 170 may be formed of resin having an oxygen index of 40 to 70.

In the related art, an insulator of a coaxial cable maybe formed of flame-retardant polypropylene (RFPP). However, flame-retardant polypropylene (FRPP) has a dielectric constant of 2.7 which is higher than a dielectric constant of 2.3 of high-density polyethylene (HDPE) used to form the insulator 130 according to an embodiment of the present invention. Thus, when flame-retardant polypropylene (FRPP) is used as a material of an insulator, an attenuation (signal loss) property which is amain feature of the coaxial cable 100 is negatively influenced by flame-retardant polypropylene (FRPP). Consequently, flame-retardant polypropylene (FRPP) cannot be used as an insulating material for the coaxial cable 100 which is a PLENUM-grade coaxial cable. Thus, and the coaxial cable 100 which is a PLENUM-grade coaxial cable according to an embodiment of the present invention uses high-density polyethylene (HDPE) as a material of the insulator 130.

Flame-retardant Polyvinylidene fluoride (PVDF) having a very high oxygen index of 95% is used as a material of a jacket of a PLENUM-grade (or CMP-grade) coaxial cable according to the related art. In contrast, flame-retardant polyvinyl chloride (PVC) having an oxygen index of 40 to 70 is used as a material of the jacket 170 of the coaxial cable 100 according to an embodiment of the present invention rather than flame-retardant Polyvinylidene fluoride (PVDF). Since the cost of flame-retardant polyvinyl chloride (PVC) is far lower than the cost of flame-retardant Polyvinylidene fluoride (PVDF), a price competitiveness of the coaxial cable 100 may be secured when the jacket 170 of the coaxial cable 100 is formed of flame-retardant polyvinyl chloride (PVC).

However, flame-retardant polyvinyl chloride (PVC) has a low oxygen index and thus a CMP-grade coaxial cable cannot be manufactured by simply changing materials of the other elements thereof.

In order to secure a flame-retardant performance, in the coaxial cable 100 according to an embodiment of the present invention, and the areas of the elements (which do not contribute to increasing a flame-retardant grade) other than the jacket 170 are reduced.

In detail, and the inner conductor 110 may be formed of copper clad aluminum and the outer conductor 150 may be formed of aluminum or copper. Thus, and the flame-retardant grade of the coaxial cable 100 may be influenced by the insulator 130 in addition to the jacket 170.

The amount of the insulator 130 may be inversely proportional to the flame-retardant grade of the coaxial cable 100. Thus, even if the material of the jacket 170 is changed, and the coaxial cable 100 may satisfy a PLENUM-grade flame-retardant grade by reducing the amount of the insulator 130.

In detail, and the insulator 130 may be configured to have a cross-sectional area of 10 mm² to 16 mm² to be 4% to 9% of the whole cross-sectional area of the coaxial cable 100.

When the cross-sectional area of the insulator 130 is greater than 9% of the whole cross-sectional area of the coaxial cable 100, and the coaxial cable 100 may not satisfy a flame-retardant grade. When the cross-sectional area of the insulator 130 is less than 4% of the whole cross-sectional area of the coaxial cable 100, and the plurality of ribs 133 and the like become too thin to have a strong property sufficient to separate the outer conductor 150 and the inner conductor 110 from each other.

The external diameter of the jacket 170 formed of flame-retardant PVC, i.e., and the whole external diameter D of the coaxial cable 100, may be set to be in a range of 15 mm to 17 mm.

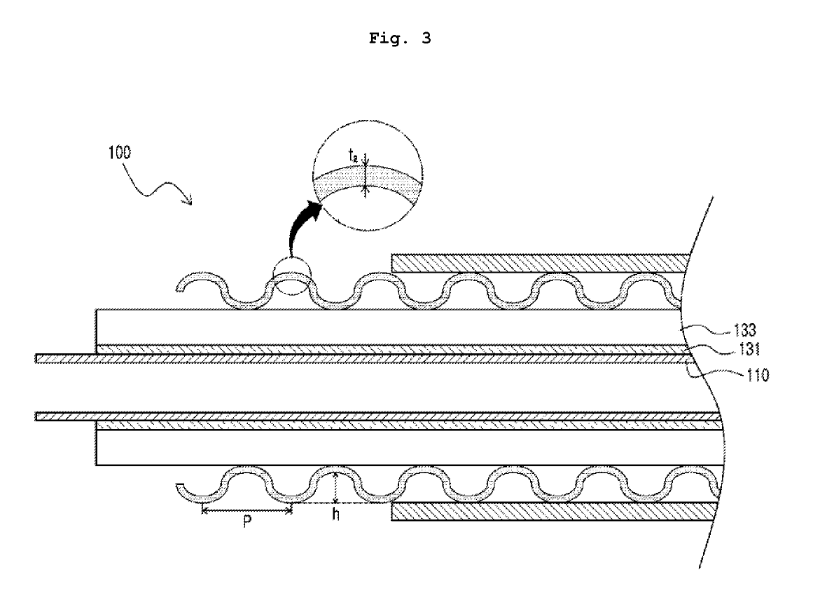

FIG. 3 is a lengthwise cross-sectional view of the coaxial cable 100 according to an embodiment of the present invention.

As described above, and the outer conductor 150 has a corrugate tubular structure. A depth h of the corrugate tubular structure of the outer conductor 150, i.e., and the difference between the heights of the ridges and furrows of the corrugate tubular structure, may be 1 mm to 1.3 mm. The corrugate tubular structure of the outer conductor 150 may have a pitch P that is in a range of about 4.8 mm to about 5.2 mm.

The outer conductor 150 may be formed of aluminum or copper, have the corrugate tubular structure, and have a thickness t₂ of 0.21 mm to 0.25 mm.

Table 1 below shows a result of conducting an experiment comparing the structure and performance of the coaxial cable 100 according to the present invention with those of a coaxial cable according to the related art.

TABLE 1

| | | Coaxial cable | Coaxial cable |
|---|---|---|---|
| | | according to | according to the |
| | | related art | present invention |
| Material of inner | | Copper clad | Copper clad |
| conductor | | aluminum | aluminum |
| Diameter (mm) of inner | | 4.82 | 4.78 |
| conductor | | | |
| Material of | | HDPE | HDPE |
| insulator | | | |
| Insulated area (mm²) | | 18.0 | 12.6 |
| Material of outer | | Copper (Cu) | Copper (Cu) or |
| conductor | | | aluminum (Al) |
| Thickness (mm) of | | 0.20 | 0.22 |
| outer conductor | | | |
| Depth (mm) of corrugate | | 0.95 | 1.1 |
| tubular structure of | | | |
| outer conductor | | | |
| Material of jacket | | flame-retardant | flame-retardant PVC |
| | | PVDF | |
| External diameter (mm) | | 14.8 | 16.0 |
| of jacket | | | |
| (cable) | | | |
| Thickness (mm) of | | 0.5 | 1.1 |
| jacket | | | |
| Impedance (Ω) | | 49.7 (good) | 50.8 (good) |
| Attenuation | Max 13.2 dB/ | 10.48 (good) | 10.83 (good) |
| (dB/100 m) | 100 m @ | | |
| | 2 GHz | | |
| CMP-grade | Peak flame | 1.52M or less | 1.52M or less |
| flame- | spread | | |
| retardant | | | |
| feature | | | |
| (based on | | | |
| NFPA 262) | | | |
| | Peak optical | 0.5 or less | 0.5 or less |
| | density | | |
| | Average | 0.15 or less | 0.15 or less |
| | optical | | |
| | dens | | |

As shown in Table 1 above, and the diameter of the inner conductor 110 of the coaxial cable 100 according to an embodiment of the present invention was less than that of an inner conductor of the coaxial cable according to the related art. In detail, and the inner conductor 110 formed of copper clad aluminum was designed to have a diameter of 4.78 mm, and thus was in a range of diameter of 3.0 mm to 5.0 mm which is a design criterion for an inner conductor according to the present invention.

In the coaxial cable 100 according to an embodiment of the present invention, and the insulator 130 covering the inner conductor 110 was formed of high-density polyethylene (HDPE), and the inner ring-shaped portion 131 was configured to cover the inner conductor 110, and the plurality of ribs 133 were configured to extend from the inner ring-shaped portion 131 in a radius direction. Furthermore, a cross-sectional area of the coaxial cable 100 was set to 12.6 mm² and was thus less than by about 30% than 18 mm² of the coaxial cable according to the related art. Thus, a decrease in the flame-retardant grade of the coaxial cable 100 caused by a change in the material of the jacket 170 may be compensated for. A cross-sectional area of the insulator 130 may be set to be in a range of 10 mm² to 16 mm².

The thickness t₂ of the outer conductor 150 and the depth h of the outer conductor 150 which is the difference between the heights of the ridges and furrows of the corrugate tubular structure were designed to be 1.1 mm so as to satisfy a range of depth of 1 mm to 1.3 mm which is a design criterion for a depth of the outer conductor 150 of the coaxial cable 100 according to an embodiment of the present invention. Thus, and the depth h of the outer conductor 150 was set to be greater than the depth of 0.95 mm of an outer conductor of the coaxial cable according to the related art. Accordingly, and the strong and flexible properties of the coaxial cable 100 according to an embodiment of the present invention were higher than those of the coaxial cable according to the related art.

Although the material of the jacket 170 covering the outer conductor 150 was changed from expensive flame-retardant PVDF to relatively cheap flame-retardant PVC and the thickness of the jacket 170 was increased from 0.5 mm to 1.1 mm, and the cross-sectional area of the insulator 130 decreased to compensate for a decrease in the flame-retardant grade of the coaxial cable 100 as described above.

In the NFPA 262 test (standard method of test for flame travel and smoke of wires and cables for use in air-handling spaces), and the coaxial cable 100 had a peak flame spread of 1.52 M or less, an optical transmittance-based peak flame spread of 0.5 or less, and an average optical density of 0.15 or less, similar to the PLENUM-grade (or CMP-grade) coaxial cable according to the related art. That is, although the structure of the coaxial cable 100 was changed as described above, and the coaxial cable 100 satisfied all of conditions required to achieve PLENUM-grade flame-retardant characteristics in the NFPA 262 test.

Also, in a test of measuring an attenuation property of the coaxial cable 100 which exhibits electrical characteristics, a loss in a 2-GHz signal per 100 meters was 10.83 dB and thus was less than a maximum reference attenuation rate of 13.2 dB. Thus, and the coaxial cable 100 satisfied a required attenuation condition.

As described above, a coaxial cable according to an embodiment of the present invention may satisfy a required PLENUM-grade flame-retardant rank even when a jacket is formed of flame-retardant PVC which is a cheap material rather than a flame-retardant PVDF.

Also, and the price competitiveness of the coaxial cable according to an embodiment of the present invention may be secured by changing a material thereof.

Also, and the coaxial cable according to an embodiment of the present invention may not only secure price competitiveness and a flame-retardant grade but also satisfy electrical characteristics, e.g., attenuation characteristics, etc.

While exemplary embodiments of the invention have been particularly shown and described, it will be understood by those of ordinary skill in the art that various changes in form and details may be made therein without departing from the spirit and scope of the invention as defined by the appended claims.

What is claimed is:

1. A coaxial cable comprising:
an inner conductor formed of copper clad aluminum;
an insulator configured to cover the inner conductor and formed of high-density polyethylene (HDPE);
an outer conductor configured to cover an outer side of the insulator and formed of copper or aluminum; and
a jacket configured to cover an outer side of the outer conductor and formed of flame-retardant polyvinyl chloride (PVC).

2. The coaxial cable of claim 1, wherein the inner conductor has a diameter of 3.0 mm to 5.0 mm.

3. The coaxial cable of claim 1, wherein the insulator has a crisscross structure in which the inner conductor is disposed to pass through a center of the insulator and a plurality of ribs extend in four directions.

4. The coaxial cable of claim 1, wherein a cross-sectional area of the insulator is in a range of 10 mm² to 16 mm².

5. The coaxial cable of claim 1, wherein the outer conductor has a corrugate tubular structure, and has a thickness of 0.21 mm to 0.25 mm.

6. The coaxial cable of claim 1, wherein a corrugate tubular structure of the outer conductor has a depth of 1.0 mm to 1.3 mm.

7. The coaxial cable of claim 1, wherein flame-retardant polyvinyl chloride (PVC) used to form the jacket has an oxygen index of 40 to 70.

8. The coaxial cable of claim 1, wherein the jacket has an external diameter that is in a range of 15 mm to 17 mm.

9. The coaxial cable of claim 1, wherein a loss in a 2-GHz signal per 100 meters is 13.2 dB or less.

10. The coaxial cable of claim 1, wherein the coaxial cable satisfies a PLENUM-grade flame-retardant rank in the NFPA 262 test,
a loss in a 2-GHz signal per 100 meters is 13.2 dB or less, and
a characteristic impedance of the coaxial cable is 52Ω.

11. A coaxial cable which includes an inner conductor at a center, an insulator covering an outer side of the inner conductor, an outer conductor covering an outer side of the insulator, and a jacket covering an outer side of the outer conductor, wherein the insulator forms an air layer between the inner conductor and the outer conductor,
the jacket is formed of resin having an oxygen index of 40 to 70.
a cross-sectional area of the insulator is 4.0% to 9.0% of a whole cross-sectional area of the coaxial cable, and
the coaxial cable has a peak flame spread of 1.52 m or less, a peak optical density of 0.5 or less, and an average optical density of 0.15 or less in the NFPA 262 test, has a characteristic impedance of 48Ω to 52Ω, and has a signal loss of 13.2 dB or less per 100 meters at a frequency of 2 GHz.

12. The coaxial cable of claim 11, wherein the inner conductor is formed of copper clad aluminum.

13. The coaxial cable of claim 12, wherein the inner conductor has a diameter of 3.0 mm to 5.0 mm.

14. The coaxial cable of claim 11, wherein the insulator comprises:
an inner ring-shaped portion covering the inner conductor; and
a plurality of ribs extending from the inner ring-shaped portion in a radius direction.

15. The coaxial cable of claim 14, wherein the insulator has a cross-sectional area of 10 mm² to 16 mm².

16. The coaxial cable of claim 11, wherein the outer conductor is formed of copper or aluminum.

17. The coaxial cable of claim 16, wherein the outer conductor has a corrugate tubular structure, and has a thickness of 0.21 mm to 0.25 mm.

18. The coaxial cable of claim 16, wherein the outer conductor has a corrugate tubular structure with ridges and furrow,
wherein a depth of the corrugate tubular structure is 1.0 mm to 1.3 mm, wherein the depth corresponds to the difference between heights of the ridges and the furrows of the corrugate tubular structure.

19. The coaxial cable of claim 11, wherein an external diameter of the coaxial cable is in a range of 15 mm to 17 mm.

20. The coaxial cable of claim 14, wherein four spaces are formed between the outer conductor and the insulator due to the plurality of ribs of the insulator.

21. The coaxial cable of claim 11, wherein the insulator is formed of high-density polyethylene (HDPE).

22. The coaxial cable of claim 11, wherein the jacket is formed of flame-retardant polyvinyl chloride (PVC).

23. A coaxial cable comprising:
an inner conductor having an external diameter of 5.0 mm or less;
an insulator configured to cover the inner conductor, formed of high-density polyethylene (HDPE), and having a cross-sectional area of 10 mm² to 16 mm²,
wherein the insulator comprises:
an inner ring-shaped portion covering the inner conductor; and
a plurality of ribs extending from the inner ring-shaped portion in a radius direction
an outer conductor configured to cover an outer surface of the insulator and having a corrugate tubular structure with ridges and furrows; and
a jacket configured to cover an outer side of the outer conductor, and formed of polyvinyl chloride (PVC) having an oxygen index of 40 to 70,
wherein the coaxial cable has an external diameter of 15 mm to 17 mm.

24. The coaxial cable of claim 23, wherein the inner conductor is formed of copper clad aluminum.

25. The coaxial cable of claim 23, wherein the outer conductor is formed of copper or aluminum.

26. The coaxial cable of claim 23, wherein the coaxial cable has a peak flame spread of 1.52 m or less, a peak optical density of 0.5 or less, and an average optical density of 0.15 or less in the NFPA 262 test, has a characteristic impedance of 48Ω to 52Ω, and has a signal loss of 13.2 dB or less per 100 meters at a frequency of 2 GHz.

27. The coaxial cable of claim 23, wherein the outer conductor has a corrugate tubular structure, and has a thickness of 0.21 mm to 0.25 mm.

28. The coaxial cable of claim 27, wherein the corrugate tubular structure of the outer conductor comprises ridges and furrows,
wherein the difference between heights of the ridges and furrows of the corrugate tubular structure is 1.0 mm to 1.3 mm.
